(19) United States
(12) Patent Application Publication
(10) Pub. No.: US 2022/0289329 A1
(43) Pub. Date: Sep. 15, 2022

(54) Bicycle Safety Accessory Device

(71) Applicants: Diann Decker, Parker, CO (US); Brendan Mclaughlin, Parker, CO (US); Daniel Mclaughlin, Parker, CO (US)

(72) Inventors: Diann Decker, Parker, CO (US); Brendan Mclaughlin, Parker, CO (US); Daniel Mclaughlin, Parker, CO (US)

(21) Appl. No.: 17/197,031

(22) Filed: Mar. 10, 2021

(51) Int. Cl. B62J 45/00; B62J 27/00; B62J 50/40; B62J 11/00

(52) U.S. Cl. CPC B62J 45/00; B62J 27/00; B62J 50/40; B62J 11/00

(57) ABSTRACT

A bicycle safety accessory device is provided which may comprise an outer body having an internal cavity and an electronic data communication module. The electronic data communication module may be stored within the internal cavity and the internal cavity may comprise a first structural configuration defining an enclosed state and a second structural configuration defining an exposed state. In the first structural configuration, the internal cavity may be physically sealed from fluid and particulates external thereto and, in the second structural configuration, the internal cavity may be accessible to a hand of an individual. The bicycle safety accessory device further comprises a coupling mechanism which retains the outer body adjacent a recreational object in a first mode while allowing the outer body to be removed from the recreational object in a second mode.

### BACKGROUND OF THE INVENTION

As a parent or guardian, protecting a child or ward is of the highest priority. Further, there are an increasing number of child disappearances, kidnappings and other related dangerous situations that children face. However, children have a natural inclination to spend time and play outdoors. In fact, studies show that children who spend time outdoors have healthier immune systems and statistically tend to be happier. Therefore, parents must weigh the value proposition of child safety versus child happiness and wellbeing.

Specifically, most disappearances, kidnappings and other related dangerous situations result from the child leaving a ‘safe zone’ as designated by the parent or guardian. However, it is difficult for a parent to set enforceable safe zones for their child to stay within. It is within the nature of many children to push the boundaries of what is allowed in order to explore the world they find around them. Further, it is very difficult for a parent to detect when a child has gone beyond a designated safe zone. Additionally, many children do not take care of expensive personal electronic devices that may track their location, but rather they take better care of engaging toys that they can carry along with them while they play outdoors, for example.

Therefore, it would be advantageous to provide a solution to allow a parent to maintain awareness of the location of their child in real-time. Further, it would be advantageous to provide the parent with the ability to set a geofence as a safe zone within which the child may safely play. It would also be advantageous to provide the child with a recreational item comprising location-monitoring functionality that the child will take better care of and enjoy carrying with them in order to more easily and accurately monitor the location of the child. Additionally, it would be advantageous to provide parent with a notification system to alert the parent when a child moves beyond the safe zone. Further, it would be advantageous to provide the child with a notification system that alerts the child when they move beyond the safe zone.

Moreover, it would be advantageous to provide the parent with the ability to contact the child at any time, but particularly in the event the child moves beyond the safe zone. Further, it would be advantageous to provide the parent with the ability to contact emergency services based upon a child being unresponsive to parent communication attempts. Additionally, it would be advantageous to provide the patent with the ability to trigger an alarm mode at the child's location in order to notify others in the vicinity that the child is in danger.

### BRIEF DESCRIPTION OF THE DRAWINGS

FIG. 1 is an overview of a bicycle safety accessory device coupled to a bicycle frame in accordance with some embodiments of the present invention.

FIG. 2A is an overview of a bicycle safety accessory device with an electronics module removed from an internal cavity of the bicycle safety accessory device in accordance with some embodiments of the present invention.

FIG. 2B is an overview of a bicycle safety accessory device with an electronics module inserted into an internal cavity of the bicycle safety accessory device in accordance with some embodiments of the present invention.

FIG. 3A is an exploded view of a coupling mechanism for coupling a bicycle safety accessory device in accordance with some embodiments of the present invention.

FIG. 3B is an overview of a coupling mechanism for coupling a bicycle safety accessory device to a portion of a recreational object in accordance with some embodiments of the present invention.

FIG. 4 is a flow diagram of a process of utilizing a bicycle safety accessory device in accordance with some embodiments of the present invention.

FIG. 5A is a wireframe of a graphical interface displayed by a personal electronic device associated with a bicycle safety accessory device in accordance with some embodiments of the present invention.

FIG. 5B is a wireframe a wireframe of a graphical interface displayed by a personal electronic device associated with a bicycle safety accessory device in accordance with some embodiments of the present invention.

### DETAILED DESCRIPTION OF THE INVENTION

In some embodiments, a bicycle safety accessory device is provided comprising an outer body comprising an internal cavity and an electronic data communication module, wherein the electronic data communication module is stored within the internal cavity, wherein the internal cavity comprises a first structural configuration defining an enclosed state and a second structural configuration defining an exposed state, wherein in the first structural configuration the internal cavity is physically sealed from fluid and particulates external thereto and in the second structural configuration the internal cavity is accessible to a hand of an individual; and a coupling mechanism, wherein the coupling mechanism retains the outer body adjacent a recreational object in a first mode and the coupling mechanism allows the outer body to be removed from the recreational object in a second mode.

In some embodiments, the internal cavity comprises a first side seam and a second side seam, and wherein the first side seam and the second side seam are coupled together in the enclosed state and the first side seam and the second side seam are not coupled together in the exposed state.

In some embodiments, the recreational object is one of: a bicycle, a tricycle, a scooter, a wagon, a rollerblade, a roller-skate and an electric recreation vehicle.

In some embodiments, the electronic data communication module comprises an enclosed case with a charging port and a removable cover, wherein the enclosed case encloses one or more of the following: at least one illumination device, at least one location tracking device, at least one microphone, at least one speaker, at least one camera, at least one display screen, at least one telephonic communication device and at least one portable power device.

In some embodiments, the coupling device comprises one or more of the following: at least one strap, at least one belt, at least one buckle, at least one bolt, at least one washer, at least one nut, at least one thread, at least one frame, at least one clamp, at least one strip of hook and loop fasteners and at least one magnet.

In some embodiments, the outer body defines at least part of a child toy.

In some embodiments, the outer body maintains structural integrity after at least five iterations of machine-washing and after at least five iterations of machine-drying.

In some embodiments, the outer body maintains the same external width, length, thickness and radius of curvature dimensions, each dimension within an error range of +/−15%, before the five iterations of machine-washing and the five iterations of machine-drying as after the five iterations of machine-washing and the five iterations of machine-drying.

In some embodiments, a personal electronic device of the individual wirelessly communicates data to the electronic data communication module and receives data from the electronic data communication module.

In some embodiments, the data comprises location-tracking data representing a real-time position of the outer body, and wherein the real-time position of the outer body is displayed to the individual via a display screen of the personal electronic device of the individual.

In some embodiments, the personal electronic device of the individual notifies the individual when the real-time position of the outer body moves beyond a geofenced area previously determined by the individual via the individual physically interacting with the display screen.

In some embodiments, the individual determines the geofenced area by setting at least three bounding vertices, and wherein each of the least three bounding vertices comprises a latitudinal and longitudinal coordinate.

In some embodiments, the individual sets the geofenced area either into an active state or into an inactive state.

In some embodiments, when the individual sets the geofenced area into the inactive state, the personal electronic device of the individual does not notify the individual when the real-time position of the outer body moves beyond the geofenced area.

In some embodiments, an outer body comprising an internal cavity and an electronic data communication module, wherein the electronic data communication module is stored within the internal cavity, wherein the internal cavity comprises a first structural configuration defining an enclosed state and a second structural configuration defining an exposed state, wherein in the first structural configuration the internal cavity is physically sealed from fluid and particulates external thereto and in the second structural configuration the internal cavity is accessible to a hand of an individual, wherein a personal electronic device of the individual wirelessly communicates data to the electronic data communication module and receives data from the electronic data communication module, and wherein the personal electronic device of the individual notifies the individual when a real-time position of the outer body moves beyond a geofenced area previously determined by the individual via the individual physically interacting with a display screen of the personal electronic device; and a coupling mechanism, wherein the coupling mechanism retains the outer body adjacent a recreational object in a first mode and the coupling mechanism allows the outer body to be removed from the recreational object in a second mode.

Before describing the present invention in detail, it is to be understood that the invention is not limited to any one of the particular embodiments, which of course may vary. It is also to be understood that the terminology used herein is for the purpose of describing particular embodiments only, and therefore is not necessarily intended to be limiting. As used in this specification and the appended claims, terms in the singular and the singular forms “a,” “an,” and “the” include plural referents unless the context clearly dictates otherwise. Thus, for example, reference to “a bicycle safety accessory device” also includes a plurality of bicycle safety accessory devices, and the like.

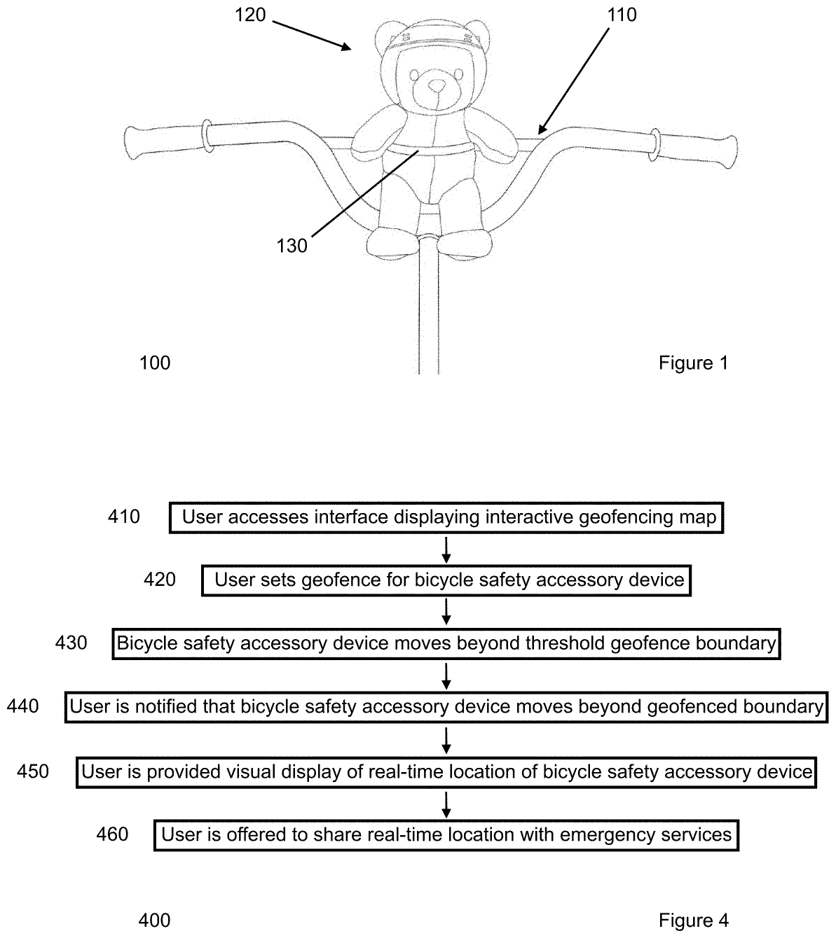

Exemplary embodiments of the present invention are illustrated in the accompanying figures. As shown in FIG. 1, a bicycle safety accessory device 100 is provided. The device 100 comprises an outer body 120 which may be attached to a recreational object 110 via a coupling mechanism 130. The recreational object 110 may be any movable object utilized by a child while playing. The outer body 120 may be any portable personal item that a child may keep with them. The coupling mechanism 130 may be any detachable structure that allows the portable personal item to retain a robust attachment to the movable object while still being selectively attached to the movable object.

The recreational object 110 may be a bicycle, tricycle, scooter, wagon, rollerblades, roller-skates, electric toy vehicle and the like or any combination thereof. In other embodiments, the recreational object 110 may be a portion of a bicycle, tricycle, scooter, wagon, rollerblades, roller-skates, electric recreation vehicle and the like or any combination thereof including, but not limited to, a support member, a frame, a handle, a seat and the like. In other embodiments, the recreational object 110 may be a helmet, kneepads, elbow pads and the like.

The outer body 120 may be a stuffed animal, a doll, a blanket, a flasher, a flashlight, a reflector, a backpack, a purse, a fanny pack, a pouch and the like or any combination thereof. In other embodiments, the outer body 120 may be any item having an enclosure disposed within it capable of containing one or more electronic components therein.

The outer body 120 may be manufactured using one or more robust, weatherproof, waterproof and/or durable materials including, but not limited to, polyurethane laminate, thermoplastic polyurethane, nylon, polyester, PVC-coated polyester, terylene, laminated cotton, laminated poplin, enameled cloth, polyester fleece, polyester microfiber, silk, cotton, wool, plush, vinyl, pleather, plastic, micro denier filament yarns and the like or any combination thereof.

The outer body 120 may be machine-washed and dried any number of times without losing structural integrity. Preferably, the outer body 120 may be machine-washed and dried at least five times on any industry-standard machine-wash and dry settings without losing structural integrity. More preferably, the outer body 120 may be machine-washed and dried at least fifteen times on any industry-standard machine-wash and dry settings without losing structural integrity. The ability of the outer body 120 to maintain structural integrity may be defined as the outer body 120 maintaining substantially the same external width, length, thickness and radius of curvature dimensions within an error range of +/−15%, but preferably within an error range of +/−5%.

The outer body 120 may further comprise one or more accessories associated therewith. For example, the outer body 120 may comprise one or more illumination elements that may selectively emit light in the visible spectrum. Specific colors of light to be emitted from the illumination elements may be selected by an individual. Additionally, in any of the embodiments disclosed in FIGS. 1-5 the illumination elements may be utilized by the device 100 when the device 100 enters an emergency status, an alarm status or a notification status. Further, the one or more accessories associated with the outer body 120 may comprise one or more helmets, jackets, pants, skirts, shirts, jerseys and the like or any combination thereof.

Further, when the device 100 enters an emergency status, an alarm status or a notification status, one or more actions may be triggered. Specifically, when the device 100 moves beyond a safe zone determined by a programmed geofenced area, the device 100 may individually, successively or simultaneously generate an alarm noise via speakers of the device 100, an alarm visual notification via illumination elements of the device 100 and/or a vibratory motion notification via an electric vibration motor of the device 100.

In some embodiments, the coupling mechanism 130 may comprise one or more of straps, belts, buckles, bolts, washers, nuts, threads, frames, clamps, hook and loop fasteners, magnets and the like or any combination thereof. In other embodiments, the coupling mechanism 130 may comprise a loop frame, a base clamp, a first base plate, a second base plate, a washer plate, a bolt, a strap having terminal couplings and the like.

Further, the coupling mechanism 130 may operate in a first mode and a second mode. In a first mode, the coupling mechanism 130 may robustly retain the outer body 120 adjacent the recreational object 110. In a second mode, the coupling mechanism 130 may allow the outer body 120 to be removed from the recreational object 110. Specifically, the one or more of straps, belts, buckles, bolts, washers, nuts, threads, frames, clamps, hook and loop fasteners, magnets, loop frame, base clamp, first base plate, second base plate, washer plate, bolt, strap having terminal couplings and the like may be structurally manipulated by the individual to retain the outer body 120 adjacent the recreational object 110 in the first mode and to allow removal of the outer body 120 from the recreational object 110 in the second mode.

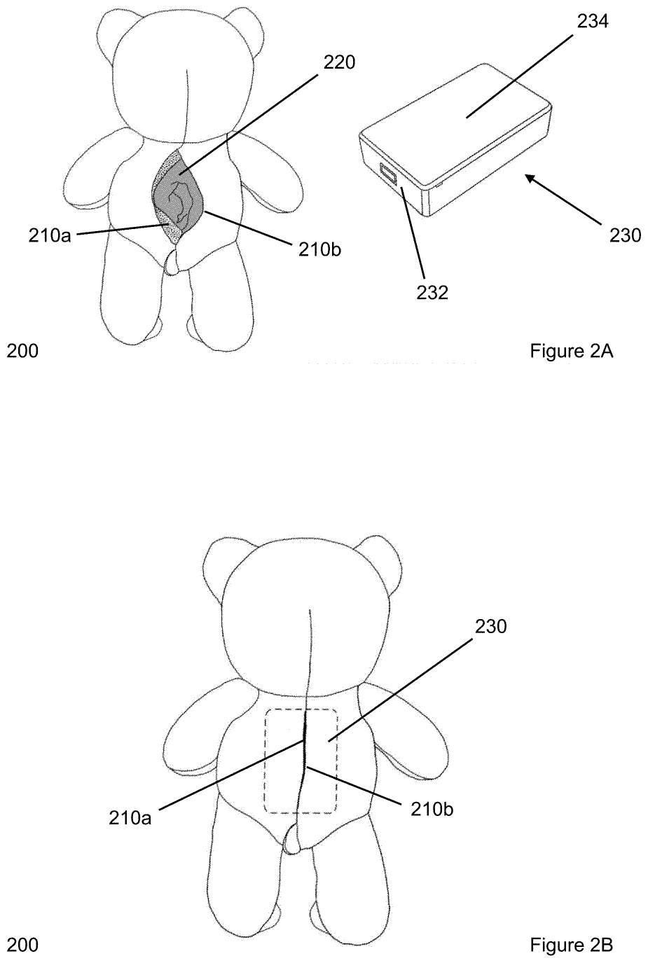

As shown in FIG. 2A, an overview of a bicycle safety accessory device 200 with an electronics module 230 removed from an internal cavity 220 of an outer body is provided. An individual may access the internal cavity 220 via a first side seam 210a and a second side seam 210b that may be removably coupled together. When the first side seam 210a and the second side seam 210b are uncoupled from one another, the internal cavity 220 is exposed to the individual. In this state, the individual may remove the electronics module 230 from the internal cavity 220 or may insert the electronics module 230 into the internal cavity 220.

The specific structural configuration of first side seam 210a and the second side seam 210b may be determined by the form the outer body takes on. In some embodiments, the outer body may be a stuffed animal and the first side seam 210a and the second side seam 210b may comprise at least one of hook and loop fasteners, zippers, snaps, buttons, magnets, clasps and the like.

In other embodiments, the outer body may be a weatherproof pouch structured for retaining and protecting the electronics module 230 within the internal cavity 220 from exposure to external environmental fluids and particulates. In some embodiments, the first side seam 210a and the second side seam 210b may comprise one or more fluid-sealing closure mechanisms to prevent environmental damage to the electronics module 230 contained within the internal cavity 220.

The internal cavity 220 may be structurally manipulated by the individual between a first structural configuration defining an enclosed state and a second structural configuration defining an exposed state. The structural manipulation of the internal cavity 220 between the enclosed and exposed states may be performed by the individual in an iterative matter as desired. In the enclosed state, the internal cavity provides a physical seal from fluids and particulates external to the cavity 220. In the exposed state, the internal cavity 220 is accessible to the individual. In this state, the individual may access the electronics module 230 for maintenance thereof.

Additionally, the internal cavity 220 may comprise a weatherproof lining that prevents moisture from entering and compromising the electronics module 230 contained therein. Such weatherproof lining may be any moisture-proof material including, but not limited to, polyurethane laminate, thermoplastic polyurethane, nylon, polyester, PVC-coated polyester, terylene, laminated cotton, laminated poplin, enameled cloth, polyester fleece, polyester microfiber, silk, cotton, wool, plush, vinyl, pleather, plastic, micro denier filament yarns and the like or any combination thereof.

Further, the internal cavity 220 may comprise a thermally-insulating lining that protects the electronics module 230 from being exposed to extreme heat or cold that may compromise its functionality. Such thermally-insulating lining may be any material having a low coefficient of thermal conductivity including, but not limited to, mineral wool, fiberglass, polystyrene, cellulose, polyurethane foam and the like or any combination thereof.

Further, the electronics module 230 may comprise one or more illumination devices, location tracking devices, audio/video devices, telephonic communication devices, portable power devices and the like or any combination thereof. The illumination devices may comprise LEDs, backlit graphical interfaces and the like. The location tracking devices may comprise global positioning satellite (GPS) compatible devices, Bluetooth® compatible devices, RFID compatible devices, cellular communication compatible devices and the like which may utilize one or more transceivers, antennae, communication controllers and the like to communicate with one or more external personal electronic devices. The audio/video devices may comprise a microphone, a speaker, a camera, a display screen and the like. The portable power devices may comprise rechargeable batteries, disposable batteries, solar-powered battery modules and the like.

Further, when the device electronics module 230 enters an emergency status, an alarm status or a notification status, one or more actions may be triggered. Specifically, when the electronics module 230 moves beyond a safe zone determined by a programmed geofenced area, the electronics module 230 may individually, successively or simultaneously generate an alarm noise via speakers of the electronics module 230, an alarm visual notification via illumination elements of the electronics module 230 and/or a vibratory motion notification via an electric vibration motor of the electronics module 230.

Additionally, the electronics module 230 may comprise one or more charging ports 232 for recharging the portable power devices between uses. The charging port s232 may include any suitable universal charging standard including, but not limited to, USB, USB-C, micro USB and the like. Further, the electronics module 230 may comprise a removable cover 234 that may allow an individual or a technician to access the electronic components therein including the portable power devices. For instance, the removable cover 234 may allow removal and insertion of new disposable batteries or replacement of a rechargeable battery after its lifespan has been exceeded.

Further, various electronic circuitry components known in the art may be utilized to electrically interconnect all of the aforementioned electronics module 230 components to effectuate associated functionality disclosed throughout this document. Such various electronic circuitry components may include, but are not limited to, resistors, capacitors, LEDs, transistors, inductors, integrated circuits and the like or any combination thereof.

As shown in FIG. 2B, an overview of a bicycle safety accessory device 200 with the electronics module 230 inserted into the internal cavity 220 of the bicycle safety accessory device 200 is provided. The first side seam 210a and the second side seam 210b are shown as being secured together to create a fluid-seal within the internal cavity 220. The fluid seal protects the electronics module 230 from the external elements outside of the outer body. The internal cavity 220 should be sized such that it can dimensionally accept the entirety of the electronics module 230.

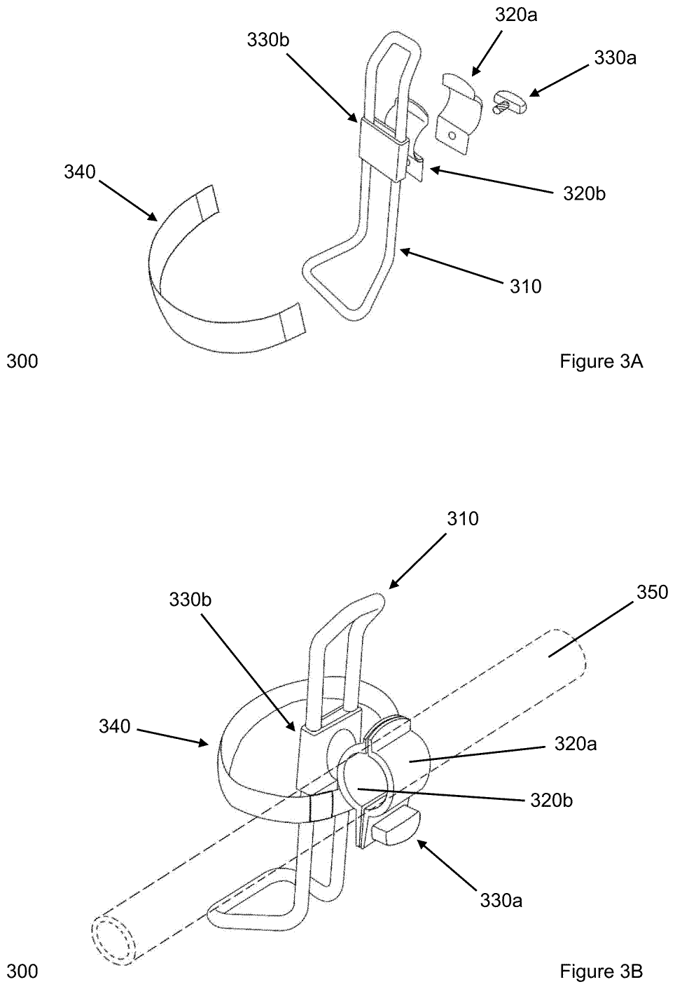

As shown in FIG. 3A, an exploded view of a coupling mechanism 300 for coupling a bicycle safety accessory device to a recreational object is provided. The coupling mechanism 300 may comprise a frame member 310 supporting a front washer 320a and rear washer 320b. Further, the frame member 310 may retain a support member 330b which comprises the rear washer 320b coupled thereto for accepting a threaded bolt 330a. Specifically, the front washer 320a and rear washer 320b may each have apertures therein for receiving the threaded bolt 330a therein. The coupling mechanism 300 may further comprise a retention belt 340 for securing the bicycle safety accessory device to a portion of the recreational object. The retention belt 340 may comprise complimentary attachment mechanisms disposed at terminal ends thereof that allow the retention belt 340 to couple to itself at terminal ends in order to secure the bicycle safety accessory device therein adjacent the frame member 310 and the threaded support member 330b.

As shown in FIG. 3B, an overview of the coupling mechanism 300 for coupling a bicycle safety accessory device to a portion of a recreational object 350 is provided. The frame member 310 provides support for the bicycle safety accessory device (not shown) via the retention belt 340 and the support member 330b. The threaded bolt 330a couples the rear washer 320b to the front washer 320a such that the portion of the recreational object 350 is secured therebetween. While the portion of the recreational object 350 is shown to be cylindrical in nature, the object 350 may take any suitable shape and so the aforementioned elements of the coupling mechanism 300 may accommodate such shapes.

As shown in FIG. 4, a process 400 of utilizing a bicycle safety accessory device is provided. In step 410, an individual may access an interface via a display of the individual's personal electronic device. The interface may display an interactive map showing a desired location. The individual may utilize the interface to create a geofenced area within the map. The geofenced area may comprise a continuous and enclosed area as defined by the individual via the interface. The geofenced area may define a safe zone within which the individual's child may safely traverse.

In step 420, an individual sets the geofenced area that defines the acceptable physical area that the bicycle safety accessory device may traverse. The geofenced area may be defined on the interface by the individual by drawing a shape with an input device upon the interface. Alternatively, the individual may define the geofenced area by dropping at least three pins upon the map. Each of the at least three pins may act as bounding vertices for the geofenced area. Each of the at least three pins may be moved by the individual after dropping them onto the map. Each of the at least three pins may represent a specific latitude and longitude. Further, the selected geofenced area may be set by the individual in an active state and an inactive state. Additionally, each geofenced area created by the individual may be saved via the interface by the individual and placed into the inactive state.

In step 430, the bicycle safety accessory device moves beyond the geofenced area set in the active state. While the individual's child is moving with the bicycle safety accessory device, the individual may view the real-time location of the bicycle safety accessory device via the display of the interface. At any point, the individual may contact the child via the individual's personal electronic device and the cellular telephonic capability of the bicycle safety accessory device.

In step 440, the individual is notified on their personal electronic device that the bicycle safety accessory device has moved outside of the safe zone defined by the geofenced area. The notification may be generated via the location tracking device of the electronics module 230 of FIG. 2A wirelessly communicating with the personal electronic device via one or more global positioning satellites, cellular towers and the like. Alternatively, the location tracking device may wirelessly communicate with the personal electronic device via short-range ultra high frequency radio wave communication protocols. In one example, the ultra high frequency radio wave communication protocols may be in the 2.402 GHz to 2.480 GHz range such as the Bluetooth® communication protocol.

Specifically, the notification may be generated when the personal electronic device determines whether the position of the bicycle safety accessory device as measured by the one or more global positioning satellites, cellular towers and the like has moved beyond the geofenced area of the safe zone as defined by the longitudinal and latitudinal coordinates of each of the at least three pins. Alternatively, one or more remote servers may determine whether the position of the bicycle safety accessory device as measured by the one or more global positioning satellites, cellular towers and the like has moved beyond the geofenced area of the safe zone as defined by the longitudinal and latitudinal coordinates of each of the at least three pins.

In step 450, the individual is provided a visual display of the location of the bicycle safety accessory device via their personal electronic device display screen. Specifically, the location of the bicycle safety accessory device as determined in step 440 is visually mapped by machine-executable software running on the personal electronic device. The software provides the individual with an interface that displays the location as a visual indicator relative the geofenced area which may be identifiably color-coded.

When the mapped location of the bicycle safety accessory device is within the geofenced area, then the geofenced area may be displayed by the interface as a first color denoting a default status. When the mapped location of the bicycle safety accessory device is outside of the geofenced area, then the geofenced area may be displayed by the interface as a second color (different from the first color) denoting an alarm status. Further, when the mapped location of the bicycle safety accessory device is within the geofenced area, then the visual indicator of the mapped location may be displayed by the interface as a third color (different from the first and second color) denoting the default status. When the mapped location of the bicycle safety accessory device is outside of the geofenced area, then the visual indicator of the mapped location may be displayed by the interface as a fourth color (different from the first, second and third colors) denoting the alarm status.

Additionally, the individual notification of step 440 and the alarm status of step 450 may comprise the personal electronic device to generate one or more audio, visual and/or tactile alerts. For example, when the child moves beyond the safe zone determined by the programmed geofenced area, the personal electronic device may individually, successively or simultaneously generate an alarm noise via speakers of the personal electronic device, an alarm visual notification via the display screen of the personal electronic device and/or a vibratory motion notification via an electric vibration motor of the personal electronic device.

In step 460, after being notified and viewing the location of the bicycle safety accessory device, the individual is offered to share the mapped location of the bicycle safety accessory device with one or more emergency services. Sharing the mapped location of the bicycle safety accessory device with one or more emergency services may involve communicating audio data, video data, location data and the like to one or more remote computers associated with the one or more emergency services. Alternatively, the communication of audio data, video data, location data and the like may be performed by the one or more remote servers of step 440.

Specifically, the display screen of the personal electronic device may display via the software interface an action button to contact one or more emergency services. After initially actuating the action button, the individual may be presented with a dialogue box on the display screen asking the individual to confirm the choice to contact emergency services. Once confirmed by the individual, the communication of audio data, video data, location data and the like to emergency services may commence.

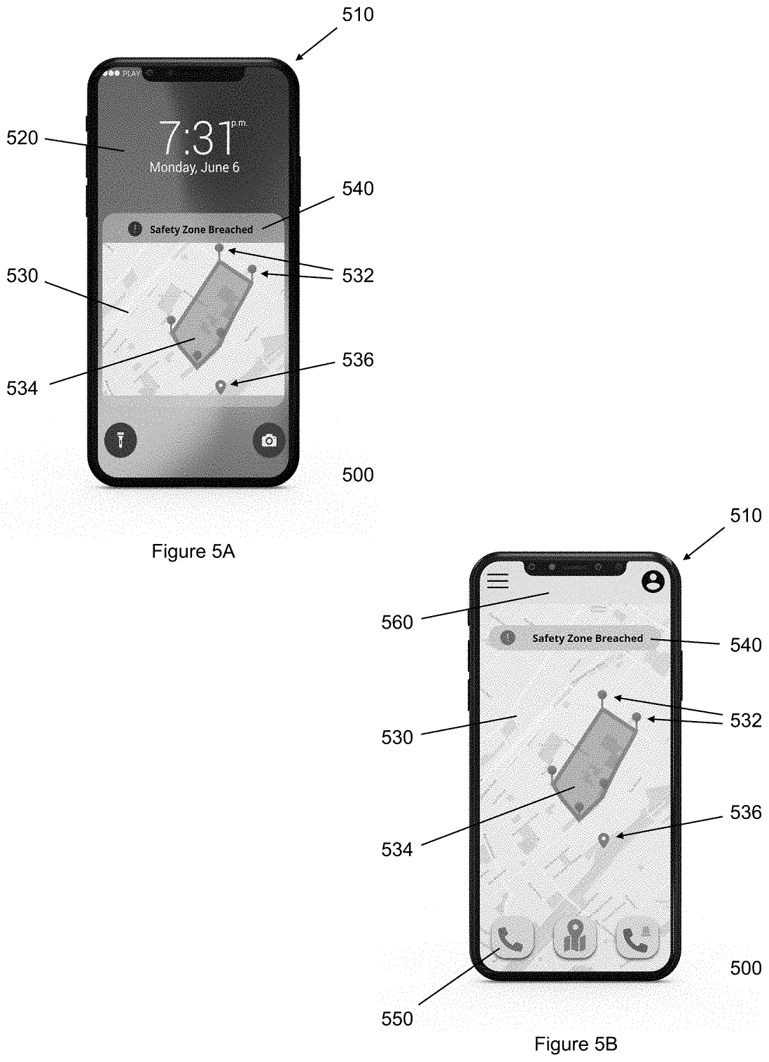

As shown in FIG. 5A, a wireframe of a graphical interface 500 displayed by a personal electronic device 510 associated with a bicycle safety accessory device is provided. Specifically, the personal electronic device 510 may comprise one or more processing devices that execute software code stored therein running an operating system. Further, the personal electronic device 510 may comprise a display screen that is configured to display the graphical interface 500 as shown.

A notification screen 520 of the operating system displayed by the display screen of the personal electronic device 510 is shown in FIG. 5A. The graphical interface 500 displays a notification 540 generated via a mobile software application stored upon the personal electronic device 510. The mobile software application causes the personal electronic device 510 to be in wireless bidirectional data communication with the electronics module 230 of FIG. 2A via one or more cell towers and/or similar data communication means. When a location indicator 536 of the electronics module 230 moves outside of a geofenced safe zone 534, the notification 540 is generated.

On the display screen of the personal electronic device 510, the notification 540 presents an individual with a map 530 comprising a plurality of geofence posts 532, the geofenced safe zone 534 and the location indicator 536. The plurality of geofence posts 532 define the boundaries of the geofenced safe zone 534 as shown in FIG. 5A. The notification 540 may further include a text notification such as “Safety Zone Breached” as illustrated in FIG. 5A or similar text informing the individual of the potentially dangerous situation. Moreover, the notification 540 may cause the personal electronic device 510 to emit audio and/or visual alerts therefrom. Specifically, the audio and/or visual alerts may include repetitive alarm noises, flashing lights and the like or any combination thereof.

Further, it is advantageous to produce the notification 540 containing the map 530 framed with the plurality of geofence posts 532, the geofenced safe zone 534 and the location indicator 536 upon the personal electronic device 510 in order to provide the individual immediate visual notification of the status of the location indicator 536 relative the geofenced safe zone 534. This allows the individual maximum time to respond to the potentially dangerous situation presented to a child associated with the location indicator 536.

As shown in FIG. 5B, a wireframe of a graphical interface 500 displayed by a personal electronic device 510 associated with a bicycle safety accessory device is provided. Specifically, the notification 540 of FIG. 5A may be accessed by an individual using the personal electronic device 510 by actuating the notification 540 as is known in the art. Once the notification 540 is actuated by the individual, the graphical interface 500 may present the individual with an application interface 560 filling the entirety of the display screen of the personal electronic device 510.

Specifically, the application interface 560 provides the individual with the map 530, the plurality of geofence posts 532, the geofenced safe zone 534 and the location indicator 536 along with the textual portion of the notification 540 from FIG. 5A. The application interface 560 may allow the individual to interact with the map 530 therein to allow the individual to track the location indicator across the map 530 relative the geofenced safe zone 534. Further, the application interface 560 may allow the individual to scroll, zoom in, zoom out and the like on the map 530.

Additionally, the application interface 560 provides the individual the ability to take one or more actions with respect to the electronics module 230 of FIG. 2A as it is represented by the location indicator 536. Specifically, the application interface 560 provides a plurality of action buttons 550 which may allow for the individual to place a phone or video call to the electronics module 230, request directions to the real-time location of the electronics module 230 as represented by the location indicator 536 and/or place a phone or video call to emergency services requesting emergency services personnel to the real-time location of the electronics module 230 as represented by the location indicator 536.

Accordingly, placing a phone or video call to emergency services may cause the electronics module 230 of FIG. 2A and/or the personal electronic device 510 to communicate to an emergency services server one or more of real-time location data, audio data, video data and the like or any combination thereof. Further, the personal electronic device 510 placing a phone or video call to emergency services may cause the electronics module 230 to individually, successively or simultaneously generate an alarm noise via speakers of the electronics module 230, an alarm visual notification via illumination elements of the electronics module 230 and/or a vibratory motion notification via an electric vibration motor of the electronics module 230.

The specification and drawings are to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A bicycle safety accessory device, comprising:
an outer body comprising an internal cavity and an electronic data communication module, wherein the electronic data communication module is stored within the internal cavity, wherein the internal cavity comprises a first structural configuration defining an enclosed state and a second structural configuration defining an exposed state, wherein in the first structural configuration the internal cavity is physically sealed from fluid and particulates external thereto and in the second structural configuration the internal cavity is accessible to a hand of an individual; and
a coupling mechanism, wherein the coupling mechanism retains the outer body adjacent a recreational object in a first mode and the coupling mechanism allows the outer body to be removed from the recreational object in a second mode.

2. The bicycle safety accessory device of claim 1, wherein the internal cavity comprises a first side seam and a second side seam, and wherein the first side seam and the second side seam are coupled together in the enclosed state and the first side seam and the second side seam are not coupled together in the exposed state.

3. The bicycle safety accessory device of claim 1, wherein the recreational object is one of: a bicycle, a tricycle, a scooter, a wagon, a rollerblade, a roller-skate and an electric recreation vehicle.

4. The bicycle safety accessory device of claim 1, wherein the electronic data communication module comprises an enclosed case with a charging port and a removable cover, wherein the enclosed case encloses one or more of the following: at least one illumination device, at least one location tracking device, at least one microphone, at least one speaker, at least one camera, at least one display screen, at least one telephonic communication device and at least one portable power device.

5. The bicycle safety accessory device of claim 1, wherein the coupling device comprises one or more of the following: at least one strap, at least one belt, at least one buckle, at least one bolt, at least one washer, at least one nut, at least one thread, at least one frame, at least one clamp, at least one strip of hook and loop fasteners and at least one magnet.

6. The bicycle safety accessory device of claim 1, wherein the outer body defines at least part of a child toy.

7. The bicycle safety accessory device of claim 1, wherein the outer body maintains structural integrity after at least five iterations of machine-washing and after at least five iterations of machine-drying.

8. The bicycle safety accessory device of claim 7, wherein the outer body maintains the same external width, length, thickness and radius of curvature dimensions, each dimension within an error range of +/−15%, before the five iterations of machine-washing and the five iterations of machine-drying as after the five iterations of machine-washing and the five iterations of machine-drying.

9. The bicycle safety accessory device of claim 1, wherein a personal electronic device of the individual wirelessly communicates data to the electronic data communication module and receives data from the electronic data communication module.

10. The bicycle safety accessory device of claim 9, wherein the data comprises location-tracking data representing a real-time position of the outer body, and wherein the real-time position of the outer body is displayed to the individual via a display screen of the personal electronic device of the individual.

11. The bicycle safety accessory device of claim 10, wherein the personal electronic device of the individual notifies the individual when the real-time position of the outer body moves beyond a geofenced area previously determined by the individual via the individual physically interacting with the display screen.

12. The bicycle safety accessory device of claim 11, wherein the individual determines the geofenced area by setting at least three bounding vertices, and wherein each of the least three bounding vertices comprises a latitudinal and longitudinal coordinate.

13. The bicycle safety accessory device of claim 11, wherein the individual sets the geofenced area either into an active state or into an inactive state.

14. The bicycle safety accessory device of claim 13, wherein when the individual sets the geofenced area into the inactive state, the personal electronic device of the individual does not notify the individual when the real-time position of the outer body moves beyond the geofenced area.

15. A bicycle safety accessory device, comprising:
an outer body comprising an internal cavity and an electronic data communication module, wherein the electronic data communication module is stored within the internal cavity, wherein the internal cavity comprises a first structural configuration defining an enclosed state and a second structural configuration defining an exposed state, wherein in the first structural configuration the internal cavity is physically sealed from fluid and particulates external thereto and in the second structural configuration the internal cavity is accessible to a hand of an individual,
wherein a personal electronic device of the individual wirelessly communicates data to the electronic data communication module and receives data from the electronic data communication module, and wherein the personal electronic device of the individual notifies the individual when a real-time position of the outer body moves beyond a geofenced area previously determined by the individual via the individual physically interacting with a display screen of the personal electronic device; and
a coupling mechanism, wherein the coupling mechanism retains the outer body adjacent a recreational object in a first mode and the coupling mechanism allows the outer body to be removed from the recreational object in a second mode.

16. The bicycle safety accessory device of claim 15, wherein the individual determines the geofenced area by setting at least three bounding vertices, and wherein each of the least three bounding vertices comprises a latitudinal and longitudinal coordinate.

17. The bicycle safety accessory device of claim 15, wherein when the individual sets the geofenced area into an inactive state, the personal electronic device of the individual does not notify the individual when the real-time position of the outer body moves beyond the geofenced area.

18. A bicycle safety accessory device, comprising:
an outer body comprising an internal cavity and an electronic data communication module, wherein the electronic data communication module is stored within the internal cavity, wherein the internal cavity comprises a first structural configuration defining an enclosed state and a second structural configuration defining an exposed state, wherein in the first structural configuration the internal cavity is physically sealed from fluid and particulates external thereto and in the second structural configuration the internal cavity is accessible to a hand of an individual,
wherein a personal electronic device of the individual wirelessly communicates data to the electronic data communication module and receives data from the electronic data communication module, wherein the personal electronic device of the individual notifies the individual when a real-time position of the outer body moves beyond a geofenced area previously determined by the individual via the individual physically interacting with a display screen of the personal electronic device, wherein the individual determines the geofenced area by setting at least three bounding vertices, and wherein each of the least three bounding vertices comprises a latitudinal and longitudinal coordinate; and
a coupling mechanism, wherein the coupling mechanism retains the outer body adjacent a recreational object in a first mode and the coupling mechanism allows the outer body to be removed from the recreational object in a second mode.

19. The bicycle safety accessory device of claim 18, wherein the individual sets the geofenced area either into an active state or into an inactive state.

20. The bicycle safety accessory device of claim 19, wherein when the individual sets the geofenced area into the inactive state, the personal electronic device of the individual does not notify the individual when the real-time position of the outer body moves beyond the geofenced area.
